(19) United States
(12) Patent Application Publication
(10) Pub. No.: US 2004/0052693 A1
(43) Pub. Date: Mar. 18, 2004

(54) Apparatus and method for removing NOx from the exhaust gas of an internal combustion engine

(76) Inventors: Samuel N. Crane JR., Columbus, IN (US); William Taylor III, Columbus, IN (US)

Correspondence Address: BARNES & THORNBURG, 11 SOUTH MERIDIAN, INDIANAPOLIS, IN, 46204

(21) Appl. No.: 10/246,297

(22) Filed: Sep. 18, 2002

(51) Int. Cl. B01D 53/34

(52) U.S. Cl. 422/173; 422/171; 422/186

(57) ABSTRACT

An emission abatement system includes a NO_{X} trap, a heat exchanger, and a fuel reformer. The heat exchanger cools exhaust gases from an internal combustion engine prior to advancement thereof into the NO_{X} trap. The fuel reformer reforms hydrocarbon fuels so as to produce a reformate gas which is supplied to the NO_{X} trap thereby facilitating regeneration of the NO_{X} trap at relatively cool temperatures. A method of operating an emission abatement assembly is also disclosed.

### FIELD OF THE DISCLOSURE

The present disclosure relates to generally to devices for removing NO_{X} from the exhaust gas of an internal combustion engine.

### BACKGROUND OF THE DISCLOSURE

Traps for removing NO_{X} from an exhaust gas of an internal combustion engine typically include an absorber catalyst which removes NO_{X} from the exhaust gas flow by “trapping” the NO_{X} as the exhaust gas advances therethrough. Periodically, the NO_{X} trap must be regenerated to purge the absorber catalyst of the trapped NO_{X}. In particular, the NO_{X} trap periodically undergoes a catalytic reaction in which the trapped NO_{X} is converted to less harmful gases that are subsequently exhausted from the trap. One way to regenerate a NO_{X} trap is by raising the temperature of the NO_{X} trap and thereafter injecting fuel, such as diesel fuel, into the trap.

### SUMMARY OF THE DISCLOSURE

According to one illustrative embodiment, there is provided an emission abatement assembly having a NO_{X} trap, a heat exchanger, and a fuel reformer. The heat exchanger cools exhaust gases from an internal combustion engine prior to advancement thereof into the NO_{X} trap. The fuel reformer reforms hydrocarbon fuels so as to produce a reformate gas that is supplied to the NO_{X} trap thereby facilitating regeneration of the NO_{X} trap at relatively cool temperatures.

According to another illustrative embodiment, there is provided a method of operating an emission abatement device which includes the step of cooling exhaust gases from an internal combustion engine prior to advancement thereof into a NO_{X} trap. The method also includes the step of advancing reformate gas from a fuel reformer into the NO_{X} trap during regeneration of the trap.

The above and other features of the present disclosure will become apparent from the following description and the attached drawings.

### BRIEF DESCRIPTION OF THE DRAWINGS

FIG. 1 is a simplified block diagram of a fuel reforming assembly having a plasma fuel reformer under the control of an electronic control unit;

FIG. 2 is a diagrammatic cross sectional view of the plasma fuel reformer of FIG. 1;

FIG. 3 is a simplified block diagram of an emission abatement assembly for removing NO_{X} from the exhaust gases of an internal combustion engine;

FIG. 4 is a graph which shows the relationship between the NO_{X} conversion rate of a NO_{X} trap and the temperature of the NO_{X} trap; and

FIG. 5 is a flowchart of a control procedure executed by a control unit during operation of the emission abatement assembly of FIG. 3.

### DETAILED DESCRIPTION OF THE DRAWINGS

As will herein be described in more detail, a heat management scheme is utilized to maintain the temperature of a NO_{X} trap within a desired temperature range that corresponds to a desired, enhanced NO_{X} conversion rate. To prevent the temperature of the NO_{X} trap from having to be increased to a temperature outside of the desired range during regeneration of the trap, a fuel reformer is utilized to generate and supply a reformate gas to the NO_{X} trap to facilitate regeneration of the trap at cooler temperatures relative to the temperatures experienced in conventional approaches in which a hydrocarbon fuel, such as diesel fuel or gasoline, is utilized to regenerate the trap.

The fuel reformer described herein may be embodied as any type of fuel reformer such as, for example, a catalytic fuel reformer, a thermal fuel reformer, a steam fuel reformer, or any other type of partial oxidation fuel reformer. The fuel reformer of the present disclosure may also be embodied as a plasma fuel reformer. A plasma fuel reformer uses plasma to convert a mixture of air and hydrocarbon fuel into a reformate gas which is rich in, amongst other things, hydrogen gas and carbon monoxide. Systems including plasma fuel reformers are disclosed in U.S. Pat. No. 5,425,332 issued to Rabinovich et al.; U.S. Pat. No. 5,437,250 issued to Rabinovich et al.; U.S. Pat. No. 5,409,784 issued to Bromberg et al.; and U.S. Pat. No. 5,887,554 issued to Cohn, et al., the disclosures of each of which is hereby incorporated by reference.

For purposes of the following description, the concepts of the present disclosure will herein be described in regard to a plasma fuel reformer. However, as described above, the fuel reformer of the present disclosure may be embodied as any type of fuel reformer, and the claims attached hereto should not be interpreted to be limited to any particular type of fuel reformer unless expressly defined therein.

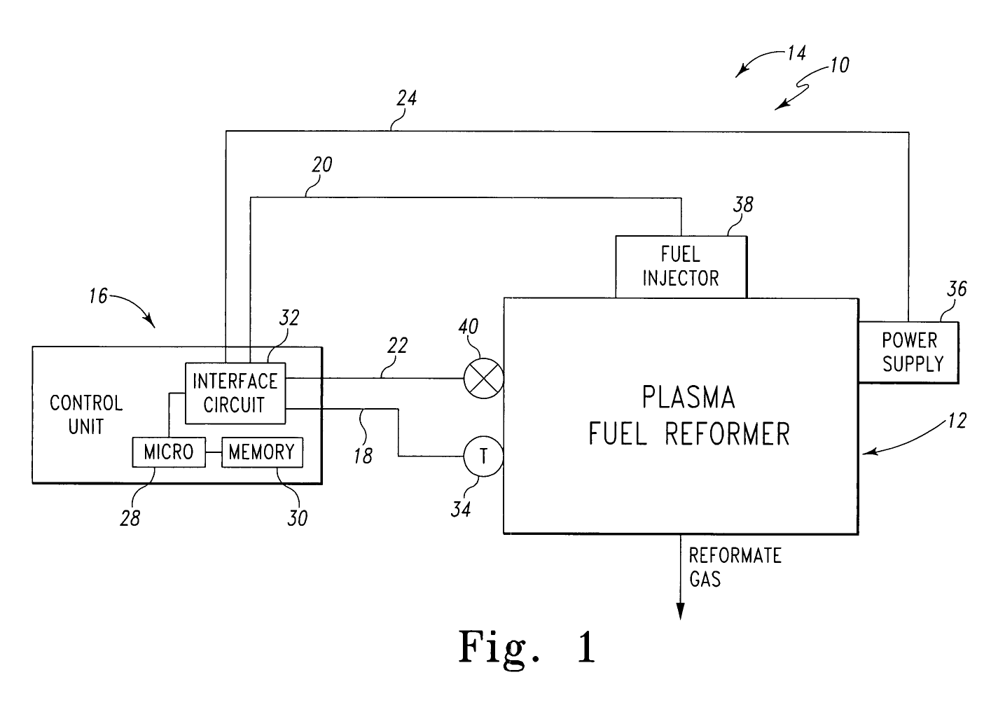

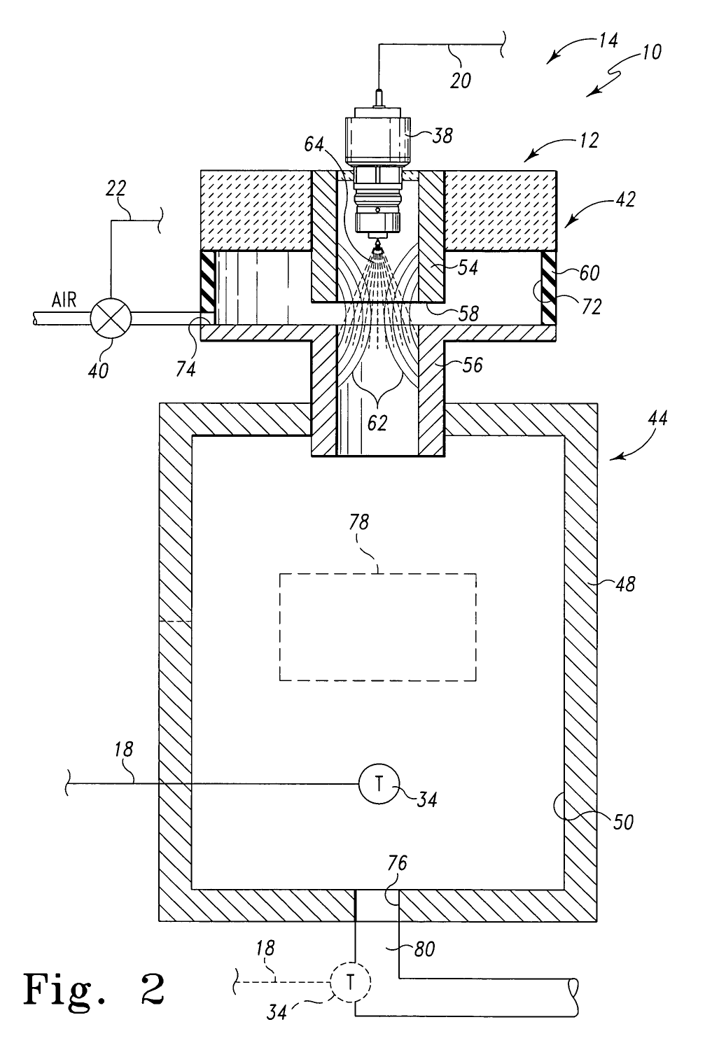

Referring now to FIGS. 1 and 2, there is shown an exemplary embodiment of a plasma fuel reforming assembly 10 of an emission abatement assembly 14. The plasma fuel reforming assembly 10 includes a plasma fuel reformer 12 and a control unit 16. The plasma fuel reformer 12 reforms (i.e., converts) hydrocarbon fuels into a reformate gas that includes, amongst other things, hydrogen and carbon monoxide. As such, the plasma fuel reformer 12, as described further herein, may be used in the construction of an onboard fuel reforming system of a vehicle or a stationary power generator. In such a way, the reformate gas produced by the onboard plasma fuel reformer 12 may be utilized to regenerate or otherwise condition an emission abatement device associated with the internal combustion engine such as a NO_{X} trap.

As shown in FIG. 2, the plasma fuel reformer 12 includes a plasma-generating assembly 42 and a reactor 44. The reactor 44 includes a reactor housing 48 having a reaction chamber 50 defined therein. The plasma-generating assembly 42 is secured to an upper portion of the reactor housing 48. The plasma-generating assembly 42 includes an upper electrode 54 and a lower electrode 56. The electrodes 54, 56 are spaced apart from one another so as to define an electrode gap 58 therebetween. An insulator 60 electrically insulates the electrodes from one another.

The electrodes 54, 56 are electrically coupled to an electrical power supply 36 (see FIG. 1) such that, when energized, an electrical current is supplied to one of the electrodes thereby generating a plasma arc 62 across the electrode gap 58 (i.e., between the electrodes 54, 56). A fuel input mechanism such as a fuel injector 38 injects a hydrocarbon fuel 64 into the plasma arc 62. The fuel injector 38 may be any type of fuel injection mechanism which injects a desired amount of fuel into plasma-generating assembly 42. In certain configurations, it may be desirable to atomize the fuel prior to, or during, injection of the fuel into the plasma-generating assembly 42. Such fuel injector assemblies (i.e., injectors which atomize the fuel) are commercially available.

As shown in FIG. 2, the plasma-generating assembly 42 has an annular air chamber 72. Pressurized air is advanced into the air chamber 72 through an air inlet 74 and is thereafter directed radially inwardly through the electrode gap 58 so as to “bend” the plasma arc 62 inwardly. Such bending of the plasma arc 62 ensures that the injected fuel 64 is directed through the plasma arc 62. Such bending of the plasma arc 62 also reduces erosion of the electrodes 56, 58. Moreover, advancement of air into the electrode gap 58 also produces a desired mixture of air and fuel (“air/fuel mixture”). In particular, the plasma reformer 12 reforms or otherwise processes the fuel in the form of a mixture of air and fuel. The air-to-fuel ratio of the air/fuel mixture being reformed by the fuel reformer is controlled via control of the fuel injector 38 and an air inlet valve 40. The air inlet valve 40 may be embodied as any type of electronically-controlled air valve. The air inlet valve 40 may be embodied as a discrete device, as shown in FIG. 2, or may be integrated into the design of the plasma fuel reformer 12. In either case, the air inlet valve 40 controls the amount of air that is introduced into the plasma-generating assembly 42 thereby controlling the air-to-fuel ratio of the air/fuel mixture being processed by the plasma fuel reformer 12.

The lower electrode 56 extends downwardly into the reactor housing 48. As such, gas (either reformed or partially reformed) exiting the plasma arc 62 is advanced into the reaction chamber 50. A catalyst 78 may be positioned in the reaction chamber 50. The catalyst 78 completes the fuel reforming process, or otherwise treats the gas, prior to exit of the reformate gas through a gas outlet 76. In particular, some or all of the gas exiting the plasma-generating assembly 42 may only be partially reformed, and the catalyst 78 is configured to complete the reforming process (i.e., catalyze a reaction which completes the reforming process of the partially reformed gas exiting the plasma-generating assembly 42). The catalyst 78 may be embodied as any type of catalyst that is configured to catalyze such reactions. In one exemplary embodiment, the catalyst 78 is embodied as substrate having a precious metal or other type of catalytic material disposed thereon. Such a substrate may be constructed of ceramic, metal, or other suitable material. The catalytic material may be, for example, embodied as platinum, rhodium, palladium, including combinations thereof, along with any other similar catalytic materials. In certain configurations, the plasma fuel reformer 12 may be embodied without the catalyst 78.

As shown in FIG. 2, the plasma fuel reformer 12 has a temperature sensor 34 associated therewith. The temperature sensor 34 is used as a feedback mechanism to determine the temperature of a desired structure of the plasma fuel reformer 12 or the gas advancing therethrough. For example, the temperature sensor 34 may be used to measure the temperature of the reformate gas being produced by the plasma fuel reformer 12, the ambient temperature within the reaction chamber 50, the temperature of the catalyst 78, etcetera. The temperature sensor 34 may be located in any number of locations. In particular, as shown in solid lines, the temperature sensor 34 may be positioned within the reaction chamber 50 at location in operative contact with the a structure (e.g., the catalyst 78 or the walls of the reaction chamber 50) or a substance (e.g., the gas in the reaction chamber 50). To do so, the temperature sensor 34 may be positioned in physical contact with the structure or substance, or may be positioned a predetermined distance away from the structure or out of the flow of the substance, depending on the type and configuration of the temperature sensor.

Alternatively, the temperature of the desired structure or substance may be determined indirectly. In particular, as shown in phantom, the temperature sensor 34 may be positioned so as to sense the temperature of the reformate gas advancing through the reaction chamber 50 or a gas conduit 80 subsequent to being exhausted through the outlet 76. Such a temperature reading may be utilized to calculate the temperature of another structure such as, for example, the catalyst 78 or the reactor housing 48. Conversely, the temperature sensor 34 may be positioned to sense the temperature of the reactor housing 48 with such a temperature reading then being correlated to the temperature of the reformate gas. In any such case, an indirect temperature sensed by the temperature sensor 34 may be correlated to a desired temperature.

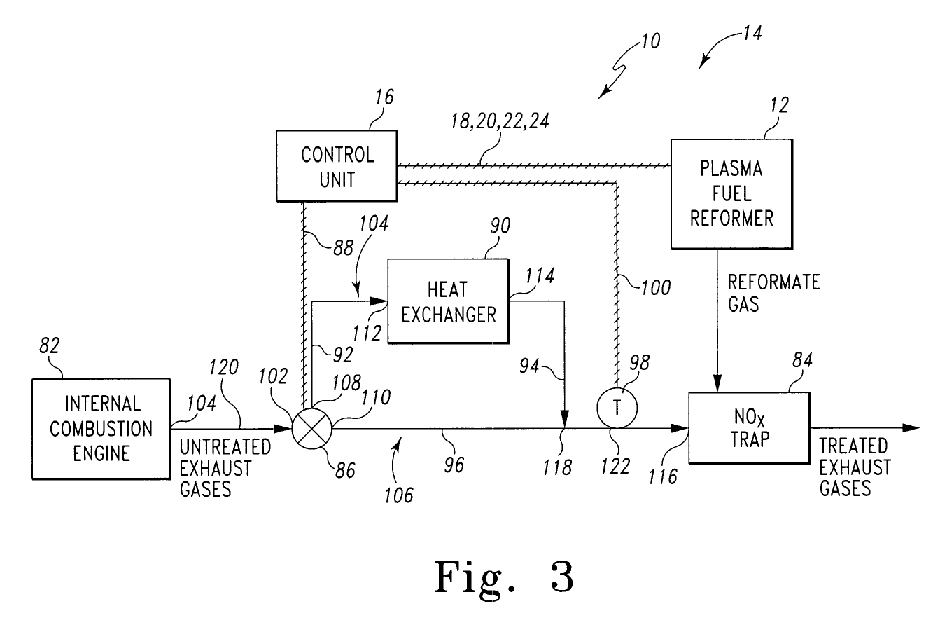

As shown in FIG. 1, the plasma fuel reformer 12 and its associated components are under the control of the control unit 16. In particular, the temperature sensor 34 is electrically coupled to the electronic control unit 16 via a signal line 18, the fuel injector 38 is electrically coupled to the electronic control unit 16 via a signal line 20, the air inlet valve 40 is electrically coupled to the electronic control unit 16 via a signal line 22, and the power supply 36 is electrically coupled to the electronic control unit 16 via a signal line 24. Moreover, as will herein be described in greater detail, a number of other components associated with an emission abatement assembly may also be under the control of the control unit 16, and, as a result, electrically coupled thereto. For example, as shown in FIG. 3, a flow diverter valve 86 for selectively diverting a flow of exhaust gas from an internal combustion engine 82 may be under the control of the control unit 16. Moreover, a temperature sensor 98 for sensing the temperature of exhaust gases entering a NO_{X} trap 84 may also be under the control of the control unit 16.

Although the signal lines 18, 20, 22, 24 (and the signal lines used to couple the diverter valve 86 and the temperature sensor 98 to the control unit 16) are shown schematically as a single line, it should be appreciated that the signal lines may be configured as any type of signal carrying assembly which allows for the transmission of electrical signals in either one or both directions between the electronic control unit 16 and the corresponding component. For example, any one or more of the signal lines 18, 20, 22, 24 (along with the signal lines used to couple the diverter valve 86 and the temperature sensor 98 to the control unit 16) may be embodied as a wiring harness having a number of signal lines which transmit electrical signals between the electronic control unit 16 and the corresponding component. It should be appreciated that any number of other wiring configurations may also be used. For example, individual signal wires may be used, or a system utilizing a signal multiplexer may be used for the design of any one or more of the signal lines 18, 20, 22, 24 (along with the signal lines used to couple the diverter valve 86 and the temperature sensor 98 to the control unit 16). Moreover, the signal lines 18, 20, 22, 24 (along with the signal lines used to couple the diverter valve 86 and the temperature sensor 98 to the control unit 16) may be integrated such that a single harness or system is utilized to electrically couple some or all of the components associated with the plasma fuel reformer 12 to the electronic control unit 16.

The electronic control unit 16 is, in essence, the master computer responsible for interpreting electrical signals sent by sensors associated with the emission abatement assembly 14 and for activating electronically-controlled components associated with the emission abatement assembly 14 in order to control the plasma fuel reformer 12, the flow of reformate gas exiting therefrom, and the exhaust gas flow from an internal combustion engine. For example, the electronic control unit 16 of the present disclosure is operable to, amongst many other things, determine the beginning and end of each injection cycle of fuel into the plasma-generating assembly 42, calculate and control the amount and ratio of air and fuel to be introduced into the plasma-generating assembly 42, determine the temperature of the reformer 12 or the reformate gas, determine the power level to supply to the plasma fuel reformer 12, determine whether to raise or lower the temperature of the exhaust gas entering the NO_{X} trap 84 to maintain the trap within a desired temperature range.

To do so, the electronic control unit 16 includes a number of electronic components commonly associated with electronic units which are utilized in the control of electromechanical systems. For example, the electronic control unit 16 may include, amongst other components customarily included in such devices, a processor such as a microprocessor 28 and a memory device 30 such as a programmable read-only memory device (“PROM”) including erasable PROM's (EPROM's or EEPROM's). The memory device 30 is configured to store, amongst other things, instructions in the form of, for example, a software routine (or routines) which, when executed by the processor 28, allows the electronic control unit 16 to control operation of the plasma fuel reformer 12.

The electronic control unit 16 also includes an analog interface circuit 32. The analog interface circuit 32 converts the output signals from the various sensors associated with the emission abatement assembly 14 into a signal which is suitable for presentation to an input of the microprocessor 28. In particular, the analog interface circuit 32, by use of an analog-to-digital (A/D) converter (not shown) or the like, converts the analog signals generated by the sensors into a digital signal for use by the microprocessor 28. It should be appreciated that the A/D converter may be embodied as a discrete device or number of devices, or may be integrated into the microprocessor 28. It should also be appreciated that if any one or more of the sensors associated with the emission abatement assembly 14 generate a digital output signal, the analog interface circuit 32 may be bypassed.

Similarly, the analog interface circuit 32 converts signals from the microprocessor 28 into an output signal which is suitable for presentation to the electrically-controlled components associated with the emission abatement assembly 14 (e.g., the fuel injector 38, the air inlet valve 40, the power supply 36, the exhaust gas flow diverter valve 86, etcetera). In particular, the analog interface circuit 32, by use of a digital-to-analog (D/A) converter (not shown) or the like, converts the digital signals generated by the microprocessor 28 into analog signals for use by the electronically-controlled components associated with the emission abatement assembly 14 such as the fuel injector 38, the air inlet valve 40, the power supply 36, or the diverter valve 86. It should be appreciated that, similar to the A/D converter described above, the D/A converter may be embodied as a discrete device or number of devices, or may be integrated into the microprocessor 28. It should also be appreciated that if any one or more of the electronically-controlled components associated with the emission abatement assembly 14 operate on a digital input signal, the analog interface circuit 32 may be bypassed.

Hence, the electronic control unit 16 may be operated to control operation of the emission abatement assembly 14. In particular, the electronic control unit 16 executes a routine including, amongst other things, a closed-loop control scheme in which the electronic control unit 16 monitors the outputs from a number of sensors in order to control the inputs to the electronically-controlled components associated with the emission abatement assembly 14. To do so, the electronic control unit 16 communicates with the sensors associated with the emission abatement assembly 14 in order to determine, amongst numerous other things, the temperature of the exhaust gas entering the NO_{X} trap 84, the saturation level of the NO_{X} trap 84, the amount, temperature, and/or pressure of air and/or fuel being supplied to the plasma fuel reformer 12, the amount of hydrogen and/or oxygen in the reformate gas, etcetera. Armed with this data, the electronic control unit 16 performs numerous calculations each second, including looking up values in preprogrammed tables, in order to execute algorithms to perform such functions as determining when or how long the fuel reformer's fuel injector is opened, controlling the power level input to the fuel reformer, controlling the amount of air advanced through the reformer's air inlet valve, controlling the position of the flow diverter valve responsible for directing the flow of exhaust gas (i.e., the diverter valve 86), etcetera.

Referring now to FIG. 3, there is shown the emission abatement assembly 14 in greater detail. The emission abatement assembly 14 includes a NO_{X} trap 84 for removing and treating NO_{X} present in an exhaust from an internal combustion engine 82 such as a diesel engine, a gasoline direct injection (GDI) engine, or natural gas engine. The NO_{X} trap 84 may be any type of commercially available NO_{X} trap including a lean NO_{X} trap so as to facilitate the trapping and removal of NO_{X} in the lean conditions associated with exhaust gases from diesel engines, GDI engines, or natural gas engines. Specific examples of NO_{X} traps which may be used as the NO_{X} trap 84 of the present disclosure include, but are not limited to, NO_{X} traps commercially available from, or NO_{X} traps constructed with materials commercially available from, EmeraChem, LLC of Knoxville, Tenn. (formerly known as Goal Line Environmental Technologies, LLC of Knoxville, Tenn.).

As shown in FIG. 3, the flow diverter valve 86 is operable to divert the flow of exhaust gases from an internal combustion engine 82 between a pair of different flow paths. In particular, the diverter valve 86 may be operated to divert a flow of exhaust gas from the engine 82 between a cooling flow path 104 and a bypass flow path 106. As shown in FIG. 3, a heat exchanger 90 is positioned in the cooling flow path 104 such that exhaust gases advancing through the cooling flow path 104 are cooled by the heat exchanger 90. The heat exchanger 90 may be embodied as any type of heat exchanger for cooling hot gases such as an air-cooled or liquid-cooled heat exchanger.

As also shown in FIG. 3, the cooling flow path 104 and the bypass flow path 106 are recombined by a flow coupler 118. The flow coupler 118 is positioned upstream of an inlet 116 of the NO_{X} trap 84. As a result, cooled exhaust gas exiting the cooling flow path 104 is reintroduced into uncooled exhaust gas from the bypass flow path 106.

In the exemplary embodiment described herein, a number of fluid lines such as tubes, pipes, or the like are utilized to create the various flow paths. In particular, an exhaust gas inlet 102 of the diverter valve 86 is fluidly coupled to an exhaust manifold 124 of the engine 82 via a fluid line 120. A first exhaust gas outlet 108 of the diverter valve 86 is fluidly coupled to an inlet 112 of a heat exchanger 90 via a fluid line 92, whereas a second exhaust gas outlet 110 of the diverter valve 86 is fluidly coupled to the flow coupler 118 via a fluid line 96. An outlet 114 of the heat exchanger 90 is fluidly coupled to the flow coupler 118 via a fluid line 94. A fluid line 122 fluidly couples the flow coupler 118 to the inlet 116 of the NO_{X} trap 84.

In such a way, cooled exhaust gas from the exhaust manifold 124 of the internal combustion engine 82 may be advanced into the NO_{X} trap 84 by directing the exhaust gas along a fluid path which includes the fluid line 120, the diverter valve 86, the fluid line 92, the heat exchanger 90, the fluid line 94, the flow coupler 118, and the fluid line 122. Conversely, uncooled exhaust gas from the exhaust manifold 124 of the internal combustion engine 82 may be advanced into the NO_{X} trap by directing the exhaust gas along a fluid path which includes the fluid line 120, the diverter valve 86, the fluid line 96, the flow coupler 118, and the fluid line 122.

The exhaust gas diverter valve 86 is embodied as a variable flow hot valve. In such a configuration, the diverter valve 86 is operable to direct a desired flow amount of exhaust gas through the cooling flow path 104, while also directing a desired flow amount of exhaust gas through the bypass flow path 106. It should be appreciated that the magnitude of the two flows determines the temperature of the gas entering the NO_{X} trap 84. In particular, by operating the diverter valve 86 to increase the magnitude of the flow through the cooling flow path 104 (and hence decrease the magnitude of the flow through the bypass flow path 106), the temperature of the resultant gas (i.e., the recombined gas flow entering the NO_{X} trap 84) is decreased. Conversely, by operating the diverter valve 86 to decrease the magnitude of the flow through the cooling flow path 104 (and hence increase the magnitude of the flow through the bypass flow path 106), the temperature of the resultant gas (i.e., the recombined gas flow entering the NO_{X} trap 84) is increased. Hence, by adjusting the position of the diverter valve 86, the temperature of the exhaust gas being introduced into the NO_{X} trap 84 can be varied.

The diverter valve 86 is electrically coupled to the electronic control unit 16 via a signal line 88. As such, the position of the diverter valve 86 is under the control of the electronic control unit 16. Hence, the electronic control unit 16, amongst its other functions, selectively diverts the flow of exhaust gas from the engine 82 between the cooling flow path 104 and the bypass flow path 106.

A temperature sensor 98 is positioned so as to sense the temperature of the recombined exhaust gas flow prior to advancement thereof into the NO_{X} trap 84. To do so, the temperature sensor 98 is fluidly interposed between the flow coupler 118 and the inlet 116 of the NO_{X} trap 84. As such, the temperature sensor 84 may be used to determine the temperature of the exhaust gas in the combined fluid line 122. The temperature sensor 98 is electrically coupled to the control unit 16 via a signal line 100. As such, the temperature sensor 98 generates output signals on the signal line 100 indicative of the temperature of the exhaust gas entering the NO_{X} trap 84.

The temperature sensor 98 is used as a feedback mechanism to maintain the NO_{X} trap in a desired temperature range by determining the temperature of the exhaust gas advancing therethrough. In particular, the output from the temperature sensor 98 is indicative of the temperature of the NO_{X} trap 84. As such, the temperature of the exhaust gas may be used to determine and monitor temperature of the NO_{X} trap 84. The temperature sensor 98 may be located in any number of locations. In particular, the temperature sensor 98 may be positioned within the fluid line 122 to sense the temperature of the exhaust gas advancing therethrough. Alternatively, the temperature of the exhaust gas may be determined indirectly. In particular, the temperature of either the inner surface or the outer surface of the fluid line 122 may be sensed. Moreover, the temperature of other structures such as, for example, the inlet 116 of the NO_{X} trap 84 may be sensed. In any such a case, the indirect temperature sensed by the temperature sensor 98 is indicative of, or otherwise may be correlated to, the temperature of the exhaust gas introduced into the NO_{X} trap 84. As such, the calculations performed by the herein described methods and systems may be adjusted to account for the use of such an indirect temperature measurements. Alternatively, the output from such an indirect gas temperature measurement may be extrapolated to a corresponding direct gas temperature or otherwise adjusted prior to input into the calculations performed by the herein described methods and systems.

Hence, it should be appreciated that the herein described concepts are not intended to be limited to any particular method or device for determining the temperature of the exhaust gas introduced into the NO_{X} trap 84. In particular, the exhaust gas temperature may be determined by use any type of temperature sensor, located in any sensor location, and utilizing any methodology (e.g., either direct or indirect) for obtaining temperature values associated with the exhaust gas.

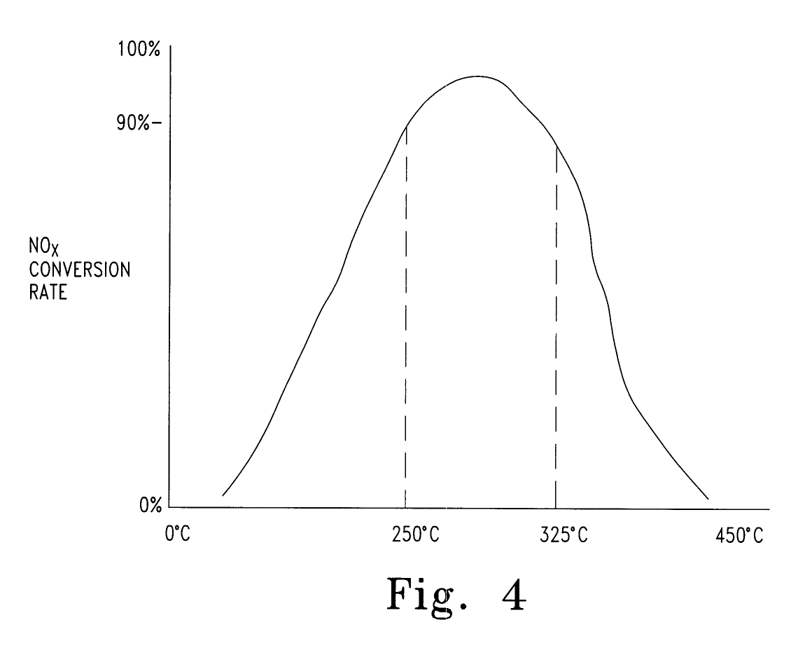

As alluded to above, the temperature of the exhaust gas may be utilized to determine temperature of the NO_{X} trap 84. As such, the temperature of the NO_{X} trap 84 may be maintained within a desirable temperature range. In particular, as shown in FIG. 4, the NO_{X} conversion rate of a given design of a NO_{X} trap varies as a function of trap temperature. The graph shown in FIG. 4 is indicative of an exemplary barium carbonate (BaCO₃) NO_{X} trap. However, it should be appreciated that a similar graph may be created for any type of NO_{X} trap to fit the needs of a given system design and, as a result, the concepts of the present disclosure are not intended to be limited to any particular type of NO_{X} trap or temperature range.

As can be seen from the graph, a desirable, relatively high NO_{X} conversion rate can be maintained by maintaining the temperature of the trap within a predetermined temperature range. For example, in the exemplary plot of the BaCO₃ NO_{X} trap shown in the graph of FIG. 4, a ninety percent (90%) NO_{X} conversion rate may be maintained by maintaining the temperature of the NO_{X} trap 84 within a temperature range of 250° C. to 325° C.

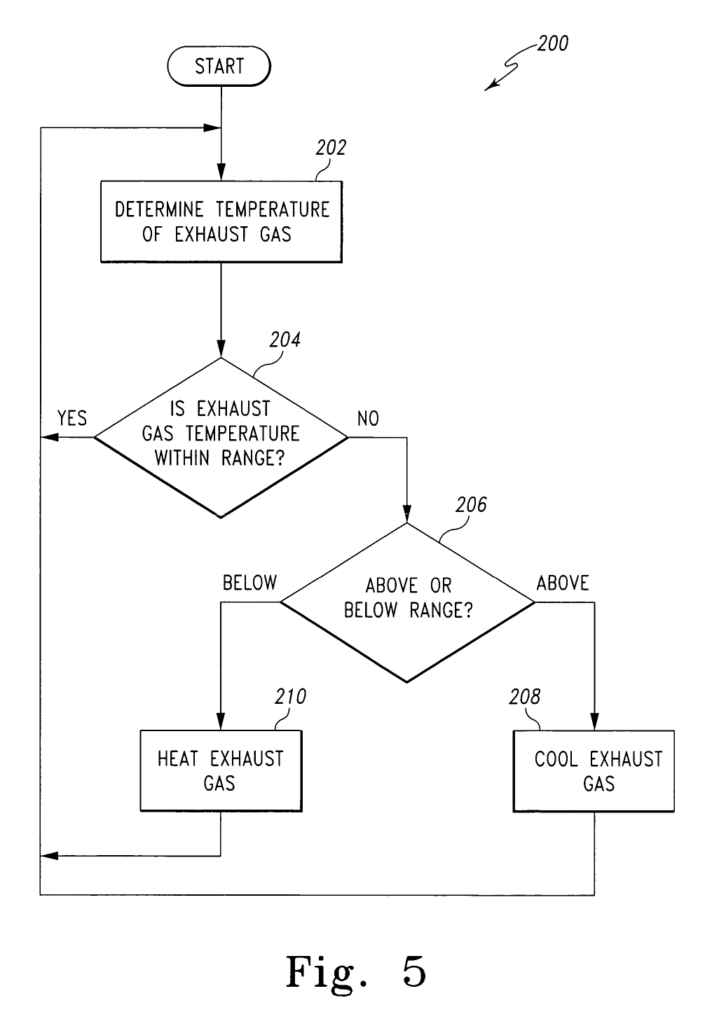

To maintain the trap temperature in any such desirable temperature range, as shown in FIG. 5, the control unit 16 executes a temperature control routine 200. The control routine 200 begins with step 202 in which the control unit 16 determines the temperature of the exhaust gas entering the NO_{X} trap 84. In particular, the control unit 16 scans or otherwise reads the signal line 100 in order to monitor output from the temperature sensor 98. As described above, the output signals produced by the temperature sensor 98 are indicative of the temperature of the exhaust gas entering the NO_{X} trap 84. Once the control unit 16 has determined the temperature of the exhaust gas entering the NO_{X} trap 84, the control routine 200 advances to step 204.

In step 204, the control unit 16 determines if the sensed temperature of the exhaust gas is within a predetermined temperature range. In particular, as described herein, a predetermined temperature range may be established which corresponds to a desired NO_{X} conversion rate of the NO_{X} trap 84. In the exemplary embodiment described herein, a trap temperature range of 250° C. to 325° C. (which corresponds with a 90% NO_{X} conversion rate) is utilized. As such, in step 204, the control unit 16 determines if the temperature of the exhaust gas is within the desired temperature range. If the temperature of the exhaust gas is within such a desired temperature range, the control routine 200 loops back to step 202 to continue monitoring the output from the temperature sensor 98. However, if the temperature of the exhaust gas is outside the desired temperature range, the control routine 200 advances to step 206.

In step 206, the control unit 16 determines if the temperature of the exhaust gas is above the desired temperature range or below the desired temperature range. If the temperature of the exhaust gas is above the desired temperature range, the control routine 200 advances to step 208. If the temperature of the exhaust gas is below the desired temperature range, the control routine 200 advances to step 210

In step 208, the control unit 16 cools the exhaust gas entering the NO_{X} trap 84. In particular, the control unit 16 generates a control signal on the signal line 88 thereby adjusting position of the diverter valve 86. More specifically, the control unit 16 adjusts the position of the diverter valve 86 so as to increase the magnitude of the flow through the cooling flow path 104 (and hence decrease the magnitude of the flow through the bypass flow path 106), thereby causing the temperature of the resultant gas (i.e., the recombined gas flow entering the NO_{X} trap 84) to be decreased. Thereafter, the control routine 200 loops back to step 202 to continue monitoring the output from the temperature sensor 98.

Referring back to step 206, if the temperature of the exhaust gas is below the desired temperature range, the control routine 200 advances to step 210. In step 210, the control unit 16 heats the exhaust gas entering the NO_{X} trap 84. In particular, the control unit 16 generates a control signal on the signal line 88 thereby adjusting position of the diverter valve 86. More specifically, the control unit 16 adjusts the position of the diverter valve 86 so as to decrease the magnitude of the flow through the cooling flow path 104 (and hence increase the magnitude of the flow through the bypass flow path 106), thereby causing the temperature of the resultant gas (i.e., the recombined gas flow entering the NO_{X} trap 84) to be increased. Thereafter, the control routine 200 loops back to step 202 to continue monitoring the output from the temperature sensor 98.

The above described control scheme may be utilized to maintain the NO_{X} trap in the desired temperature range during NO_{X} absorption. However, as will now be discussed in more detail, the NO_{X} trap 84 of the emission abatement assembly 14 may also be maintained in the desired temperature range during regeneration of the NO_{X} trap. This is desirable relative to regeneration schemes such as those which inject diesel fuel or gasoline into the NO_{X} trap. In particular, such regeneration schemes require the temperature of the trap to be significantly increased to elevated temperatures including temperatures exceeding typical exhaust gas temperatures (e.g., a temperature in excess of 600-650° C.). In such situations, the conversion rate of the NO_{X} trap is adversely affected during the transitional times associated with heating of the trap prior to regeneration and cooling of the trap subsequent to regeneration.

The plasma fuel reformer 12 is operated to facilitate regeneration of the NO_{X} trap 84 at the relatively cool temperatures within the desired temperature range. In particular, the reformate gas produced by the plasma fuel reformer 12 is rich in, amongst other things, hydrogen and carbon monoxide. Such reformate gas facilitates regeneration of the absorber catalyst of the NO_{X} trap 84 at relatively cool temperatures. Indeed, testing has shown that use of such reformate gas facilitates regeneration of the absorber catalyst of the NO_{X} trap 84 at a wide range of cool exhaust gas temperatures including transient temperatures such as the exhaust gas temperatures associated with engine idle. Hence, by use of reformate gas from the plasma fuel reformer 12 to facilitate regeneration of the NO_{X} trap 84, the temperature of the NO_{X} trap 84 may be maintained within a desirable temperature range including during regeneration.

The control scheme executed by the control unit 16 includes a routine for regenerating the NO_{X} trap. Such a regeneration control scheme may be designed in a number of different manners. For example, a timing-based control scheme may be utilized in which the NO_{X} trap 84 is regeneration as a function of time. For instance, regeneration of the NO_{X} trap 84 may be performed at predetermined timed intervals.

Alternatively, a sensor-based control scheme may be utilized. In such a case, the NO_{X} trap 84 is regenerated as a function of output from one or more sensors associated with the trap. For instance, regeneration of one of the NO_{X} trap 84 may commence when the output from NO_{X} sensor(s) (not shown) associated with the trap is indicative of a predetermined saturation level.

However, in any such case, the control scheme executed by the control unit 16 may be configured to regenerate the NO_{X} trap 84 while contemporaneously maintaining the temperature of the NO_{X} trap within a temperature range corresponding to a desired, enhanced NO_{X} conversion rate. More specifically, the control unit 16 may maintain operation of the diverter valve 86 so as to maintain the trap temperature within the desired temperature range during regeneration of the trap. In other words, the NO_{X} trap 84 need not be subjected to elevated temperatures outside of the desired range during regeneration. In such a way, periods of a reduced NO_{X} conversion rate are not realized just prior to or subsequent to regeneration of the NO_{X} trap 84.

While the disclosure is susceptible to various modifications and alternative forms, specific exemplary embodiments thereof have been shown by way of example in the drawings and has herein be described in detail. It should be understood, however, that there is no intent to limit the disclosure to the particular forms disclosed, but on the contrary, the intention is to cover all modifications, equivalents, and alternatives falling within the spirit and scope of the disclosure.

There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of apparatus, systems, and methods that incorporate one or more of the features of the present disclosure and fall within the spirit and scope of the present disclosure.

For example, it should be appreciated that in lieu of diverting only a portion of the exhaust gas through a heat exchanger, the entire exhaust gas flow may be directed through a heat exchanger. In such a case, the heat exchanger itself may be operated to adjust the temperature of the exhaust gas exiting therefrom and into the NO_{X} trap 84. For example, in the case of an air-to-air heat exchanger, the speed control of the air fan may be adjusted to adjust the temperature of the exhaust gas exiting the heat exchanger. Similarly, in the case of an air-to-liquid heat exchanger, the speed control of the pump may be adjusted to adjust the temperature of the exhaust gas exiting the heat exchanger.

In addition, the emission abatement assembly 14 may be configured to include one or more additional catalysts to function in conjunction with the NO_{X} trap 84. For example, an oxidation catalyst may be positioned upstream of the NO_{X} trap 84 to remove oxygen from the exhaust gas thereby facilitating regeneration of the trap. Moreover, an oxidation catalyst may also be positioned downstream from the NO_{X} trap 84 remove (i.e., oxidize) any residual compounds such a H₂S that may be present in the gases being exhausted from the NO_{X} trap 84.

Moreover, as described above, the plasma fuel reformer 12 may be operated to produce a reformate gas that is rich in, amongst other things, hydrogen and carbon monoxide. However, a flow of reformate gas rich in other compounds may also be produced by the plasma fuel reformer 12. For example, reformate gas rich in acetylene, methane, propanol, or ethanol may also be produced. Such a reformate gas may also be utilized to regenerate the NO_{X} trap 84 at relatively cool trap temperatures.

1. An emission abatement assembly, comprising:
a heat exchanger for cooling exhaust gas from an internal combustion engine,
a NO_{X} trap for removing NO_{X} from the exhaust gas of the internal combustion engine, the NO_{X} trap being fluidly coupled to an outlet of the heat exchanger, and
a fuel reformer for reforming a hydrocarbon fuel into a reformate gas, the fuel reformer being fluidly coupled to the NO_{X} trap.

2. The emission abatement assembly of claim 1, further comprising a flow diverter valve, wherein:
the flow diverter valve is operable to divert the exhaust gas from the internal combustion engine between a cooling flow path and a bypass flow path,
the heat exchanger is positioned in the cooling flow path, and
the heat exchanger is isolated from the bypass flow path.

3. The emission abatement assembly of claim 1, further comprising a flow diverter valve, wherein:
a first exhaust gas outlet of the flow diverter valve is fluidly coupled an inlet of the heat exchanger, and
a second exhaust gas outlet of the flow diverter valve is fluidly coupled to an exhaust gas inlet of the NO_{X} trap.

4. The emission abatement assembly of claim 3, wherein an exhaust gas inlet of the flow diverter valve is fluidly coupled to an exhaust manifold of the internal combustion engine.

5. The emission abatement assembly of claim 1, further comprising:
a temperature sensor for sensing the temperature of the exhaust gases of the internal combustion engine, and
a flow diverter valve for bypassing a portion of the exhaust gases from the internal combustion engine around the heat exchanger, wherein position of the flow diverter valve is based on output from the temperature sensor.

6. The emission abatement assembly of claim 1, wherein the fuel reformer comprises a plasma fuel reformer.

7. A method of operating an emission abatement assembly, the method comprising the steps of:
diverting a cooling flow of exhaust gas from a main flow of exhaust gas into a heat exchanger,
advancing the cooling flow of exhaust gas out of the heat exchanger and into a NO_{X} trap, and
advancing a reformate gas from a fuel reformer into the NO_{X} trap during regeneration of the NO_{X} trap.

8. The method of claim 7, wherein the step of advancing the cooling flow of exhaust gas out of the heat exchanger comprises reintroducing the cooling flow of exhaust gas into the main flow of exhaust gas prior to advancement thereof into the NO_{X} trap.

9. The method of claim 7, wherein the diverting step comprises operating a flow diverter valve so as to divert the cooling flow of exhaust gas into the heat exchanger.

10. The method of claim 7, further comprising the steps of:
reintroducing the cooling flow of exhaust gas into the main flow of exhaust gas prior to advancement thereof into the NO_{X} trap, and
sensing temperature of the main exhaust gas subsequent to the reintroducing step.

11. The method of claim 10, wherein the diverting step comprises adjusting position of a flow diverter valve based on the sensing step so as to adjust the magnitude of the cooling flow of exhaust gas being advanced into the heat exchanger.

12. A method of operating a emission abatement assembly, the method comprising the steps of:
advancing exhaust gas from an internal combustion engine through a heat exchanger so as to cool the exhaust gas from a pre-cooled exhaust gas temperature,
advancing the cooled exhaust gas through a NO_{X} trap so as to cause the NO_{X} trap to have a trap temperature which is less than the pre-cooled exhaust gas temperature, and
introducing reformate gas from a fuel reformer into the NO_{X} trap during regeneration of the NO_{X} trap, wherein the trap temperature of the NO_{X} trap is less than the pre-cooled exhaust gas during regeneration of the NO_{X} trap.

13. The method of claim 12, wherein the step of advancing the cooled exhaust gas through the NO_{X} trap comprises introducing the cooled exhaust gas into a flow of uncooled exhaust gas which bypassed the heat exchanger prior to advancement thereof into the NO_{X} trap.

14. The method of claim 12, wherein the step of advancing exhaust gas from the internal combustion engine through the heat exchanger comprises operating a flow diverter valve so as to divert the exhaust gas into the heat exchanger.

15. The method of claim 12, wherein the step of advancing the cooled exhaust gas through the NO_{X} trap comprises:
combining the cooled exhaust gas into a flow of uncooled exhaust gas which bypassed the heat exchanger prior to advancement thereof into the NO_{X} trap, and
sensing temperature of the combined flow of cooled and uncooled exhaust gas prior to advancement thereof into the NO_{X} trap.

16. An emission abatement assembly, comprising:
a flow diverter valve operable to divert a flow of exhaust gas from an internal combustion engine between a cooling flow path and a bypass flow path,
a heat exchanger positioned in the cooling flow path, the heat exchanger being configured to cool exhaust gas advancing therethrough,
a NO_{X} trap configured to remove NO_{X} from exhaust gas advancing therethrough, the NO_{X} trap being positioned in both the cooling flow path and the bypass flow path, and
a fuel reformer for reforming a hydrocarbon fuel into a reformate gas, the fuel reformer being fluidly coupled to the NO_{X} trap.

17. The emission abatement assembly of claim 16, wherein an exhaust gas inlet of the diverter valve is fluidly coupled to an exhaust manifold of the internal combustion engine.

18. The emission abatement assembly of claim 16, further comprising a temperature sensor for sensing the temperature of exhaust gas entering the NO_{X} trap, wherein position of the flow diverter valve is based on output from the temperature sensor.

19. The emission abatement assembly of claim 16, wherein the fuel reformer comprises a plasma fuel reformer.
